(19) United States
(12) Patent Application Publication
(10) Pub. No.: US 2024/0077367 A1
(43) Pub. Date: Mar. 7, 2024

(54) Remote Fluid Properties Detection and Reporting

(71) Applicants: Scott M. Hines, Canton, MI (US); Kas Kasravi, West Bloomfield, MI (US)

(72) Inventors: Scott M. Hines, Canton, MI (US); Kas Kasravi, West Bloomfield, MI (US)

(21) Appl. No.: 17/657,763

(22) Filed: Apr. 4, 2022

Related U.S. Application Data
(60) Provisional application No. 63/173,419, filed on Apr. 10, 2021.

(51) Int. Cl. G01K 11/12; G01K 1/024

(52) U.S. Cl. CPC G01K 11/12; G01K 1/024; G01K 2215/00

(57) ABSTRACT

A remote detection and reporting of fluid properties device. A float has a sensor array for detecting at least one property of a fluid and transmitting the fluid properties. The float has at least one side arm and at least one lower arm for detection of fluid properties, where the lower arm has a ballast and a gas bladder for orienting and stabilizing the float. The float, the side arms, and the lower arm are made of a thermally conductive plastic and coated with a thermochromic compound optimized for visually reporting the temperature of a fluid via change in color.

In a different embodiment of the float has an electronic sensor array detects multiple properties of a fluid. The float has an electronic transmitter, a battery, and a wire harness, and floats in a fluid. The device transmits the fluid properties to a remote receiver.

### CROSS-REFERENCE TO RELATED APPLICATIONS

This application claims the benefit of U.S. Provisional Application No. 63/173,419, filed Apr. 10, 2021. The content of U.S. Provisional Application 63/173,419 is incorporated herein by reference for all purposes.

### BACKGROUND OF THE INVENTION

The present invention relates generally to sensing physical properties and in particular to remotely detecting properties of fluids in containers.

Currently there are a number of solutions for detecting properties of fluids in containers. Some of these solutions attach a sensor to the container to measure a property such as temperature, but these solutions fail to meet the needs of the industry because the sensors are influence by the ambient condition and fail to report the actual properties within the fluid. Other solutions attach sensors inside containers, but these solutions are similarly unable to meet the needs of the industry as they measure the fluid properties at specific locations and not representative of the overall fluid properties, further, these solutions require wiring to transmit the information associated with fluid properties, which impose physical limitations to the utility of the solutions. Still further, other solutions attempt to insert probes into the fluid, which also don't meet the needs of the industry due to high maintenance requirements.

It would be desirable to have a device capable of remotely detecting and reporting properties of fluids in a container, where such properties include temperature, density, impurity, colloidal particles, viscosity, color, gas content, and chemical composition. Furthermore, it would also be desirable to have a device that easily reports the said properties to a user outside the container. Still further, it would be desirable to have a device that reports the fluid properties without physical wiring or connections. It would also be desirable to have a device that is easy to use/maintain and not require a complex installation process or physical attachments. Even further, it would be desirable to have a device that controllably floats over or within the fluid.

The present invention advantageously fills the aforementioned deficiencies by providing a device for remote detection and reporting of fluid properties, which accurately detects the fluid properties and does not require a complex installation process.

The present invention is a device for remote detection and reporting of fluid properties, which is made up of the following components: a float located within the fluid, a sensor array for detecting the desired fluid properties, a transmitter for reporting the detected fluid properties, a ballast and/or a gas bladder for controlling the buoyancy of the device within the fluid.

These components are related to each other as follows: the float contains the sensor array, the transmitter, the ballast, and the gas bladder. The sensor array detects the fluid properties and communicates the properties to the transmitter. The transmitter reports the fluid properties to a remote user in a contact-less fashion.

The present invention may also have one or more of the following: at least one side arm attaching at one end to the float and projecting away from the float that helps orient and stabilize the float over or within the fluid, and at least one lower arm attached to the bottom of the float at one end and projecting downward from the float to help detect fluid properties and stabilize the float over or within the fluid. The lower arm contains the ballast at the end not attached to the float. The float and the said arms optionally contain an embedded gas bladder. The float, the side arms, and the lower arm are made of a thermally conductive material core, preferably a thermally conductive plastic capable of sensing and propagating the fluid temperature. The entire float, the side arms, the lower arms, and the ballast are coated with a thermochromic compound that is in direct contact with the thermally conductive core, preferably thermochromic silicone calibrated to visually transmit the temperature of the fluid as detected by the float. This embodiment is configured for detecting the milk temperature in a baby milk bottle and visually displaying the milk temperature to the user via the color of the thermochromic coating.

The present invention is unique when compared with other known devices and solutions because the present invention provides: (1) a float, (2) side arms, (3) a lower arm, (4) a ballast, (5) a gas bladder, (6) thermally conductive core, and (7) thermochromic coating, collectively referred to as a float assembly.

The present invention is unique in that it is structurally different from other known devices or solutions. More specifically, the present invention is unique due to the presence of: (1) a float with a thermally conductive material to detect temperature, (2) thermochromic coating to visually communicate temperature, and (3) a combination of ballast and a gas bladder to control the buoyancy of the device within a fluid.

An electronic embodiment of the present invention may also have one or more of the following: an electronic sensor array, an electronic transmitter, a microcontroller, a battery, a wire harness, a ballast, and a gas bladder. The float contains the aforementioned components, where the electronic sensor, the electronic transmitter, the microcontroller, and the battery are connected to each other via the wire harness. The electronic sensor array is fabricated to detect the desired fluid properties. The fluid properties are then transmitted to the microcontroller, which wirelessly broadcasts the fluid properties via signals. The battery provides power to the aforementioned components. The battery is replaceable, rechargeable via wire harness or wirelessly rechargeable via induction, as desired by the user. The ballast and the gas bladder are configured to provide the desired orientation and buoyancy of the device over or within the fluid. An external remote receiver that receives signals from the electronic transmitter and conveys them to the user. This embodiment is configured for industrial applications to monitor the condition of fluids.

The electronic embodiment of the present invention is unique when compared with other known devices and solutions because the present invention provides: (1) an electronic sensor array, (2) an electronic transmitter, (3) a microcontroller, (4) a ballast, and (5) a gas bladder.

The electronic embodiment of the present invention is unique in that it is structurally different from other known devices or solutions. More specifically, the present invention is unique due to the presence of: (1) a float with a sensor array for simultaneously detecting multiple fluid properties, (2) an electronic transmitter for wirelessly signaling the fluid properties, and (3) a combination of ballast and a gas bladder to control the buoyancy of the device within a fluid.

Among other things, it is an objective of the present invention to provide a remote fluid property detection and reporting that does not suffer from any of the problems or deficiencies associated with prior solutions.

It is an objective of the present invention to accurately detect the properties of a fluid stored in a container and remotely report the fluid properties to a user. It is further an objective of the present invention to create a device that is safe and easy to use. Still further, it is an objective of the present invention to float within the fluid to obtain actual readings of the fluid and not influenced by ambient conditions.

The present invention now will be described more fully hereinafter with reference to the accompanying drawings, which are intended to be read in conjunction with both this summary, the detailed description, and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF DRAWINGS

FIG. 1 shows a perspective view of the remote fluid properties detection device.

FIG. 2A shows the top view of the remote fluid properties detection device.

FIG. 2B shows a cross section of the remote fluid properties detection device.

FIG. 3 shows a perspective view of the remote fluid properties detection device with an extraction arm.

FIG. 4 shows a perspective of the electronic embodiment of the remote fluid properties detection device.

FIG. 5A shows the top view of the electronic embodiment of the remote fluid properties detection device.

FIG. 5B shows a cross section of the electronic embodiment remote fluid properties detection device.

### DETAILED DESCRIPTION OF THE INVENTION

The present invention is directed to a device for remote fluid properties detection and reporting. The present invention comprises a float placed in a fluid whose properties are desired by a user. The float has a sensor array fabricated to measure at least one fluid property, such as temperature. The float has a transmitter fabricated to covey the desired fluid property to the user in a wireless manner. Further, the float has a ballast and a gas bladder to control the buoyancy and stabilization of the present invention in fluids. The present invention is now described in detail with reference to the attached figures.

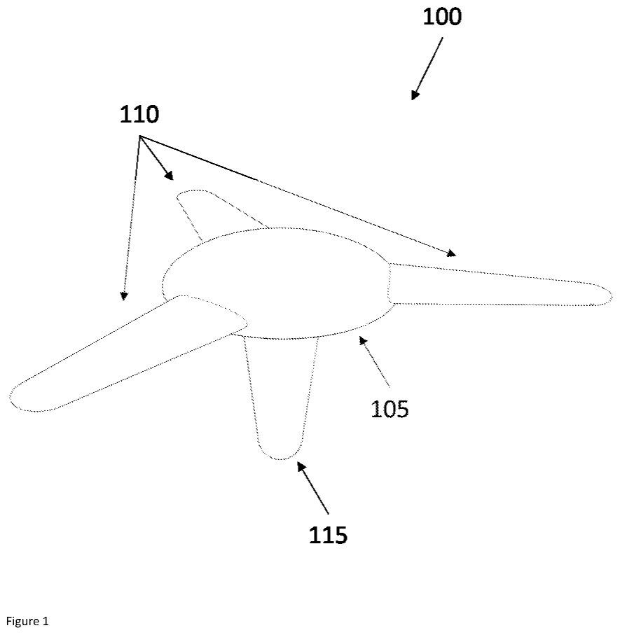

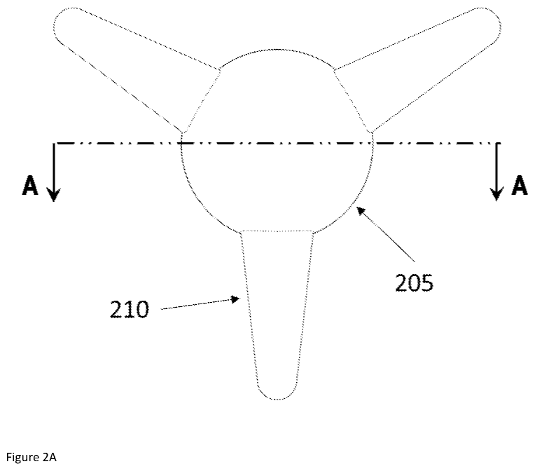

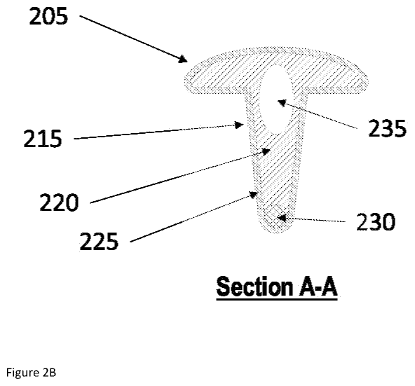

The figures herein follow a numbering convention in which the first digit or digits correspond to the drawing figure number and the remaining digits identify an element or component in the drawing. Similar elements or components between different figures may be identified using similar digits. For example, 145 may reference element “45” in FIG. 1, and a similar element may be referenced as 245 in FIG. 2. Elements shown in the various figures herein can be added, exchanged, and/or eliminated to provide a number of additional examples of the present disclosure. In addition, the proportion and the relative scale of the elements provided in the figures are intended to illustrate the examples of the present disclosure and should not be taken in a limiting sense.

FIG. 1 shows a perspective view of a device for remote fluid properties detection and reporting 100 having a float 105, at least one side arm 110, and a lower arm 115. FIG. 2A shows the top view of the present invention with the float 205 and at least one side arm 210. These elements are collectively referred to a float assembly. This embodiment of the present invention is presented with three side arms to assist with floatation of the float in fluids. Section A-A is identified and referenced in FIG. 2B.

FIG. 2B shows the front view of the section A-A, where the internal structure of the float 205 is illustrates in greater detail. The float 205 comprises the lower arm 215, a core 220, a coating 225, a ballast 230, and a gas bladder 235. The aforementioned float, side arms, and the lower arm are integrated and jointly make up the core 220. The core 220 is made of a thermally conductive material, preferably a thermally conductive plastic. The thermally conductive plastic used in the core 220 is preferably flexible. The coating 225 is made of a thermochromic compound, preferably a thermochromic silicone, where the thermochromic silicone is optionally food grade. A person having ordinary skill in the art would recognize that the thermochromic compound is available in powder, liquid, and other forms. Further, a person having ordinary skill in the art would recognize that the thermochromic compound may be embedded within a subject material, such as the coating 225, or coated under it. The ballast 230 is a dense material integrated within the end of the lower arm 215 away from the float 205 to help orient and stabilize the float 205 in fluids. The gas bladder 235 is filled with a gas, such as air, to help control the buoyancy of the float 205 in fluids. The combination of the ballast 230 and the gas bladder 235 are configured to control buoyancy, orientation, and stabilization of the float 205 in fluids. A person having ordinary skill in the art would recognize that the choice of the materials for the core 220 and the ballast 230, along with the dimensions and location of the gas bladder 235 would result in controlling the floatation location of the float 205 in fluids in a desired manner, in particular whether the float 205 floats on top of fluids, suspended within fluids, or sinks to the bottom of fluids. The floatation location increases the accuracy of the detected properties depending on the nature of the fluid and the desired properties.

The embodiment of the present invention shown in FIGS. 1, 2A, and 2B floats in fluids and the temperature of thermally conductive core 220 complies with the fluid temperature. The thermochromic coating 225 responds to the temperature of the core 220 by changing color, which is propagated across the entire float 205, the side arms 210 and the lower arm 215. A person having ordinary skill in the art would recognize that the thermochromic coating 225 can be fabricated to present specific colors and specific temperatures according to the intended use case. Thus, shortly after placing the float assembly in a desired fluid, the color of the float 205 changes, which visually transmits the fluid temperature to the user.

With reference to FIG. 1, in one embodiment the float 105, three side arms 110, and lower arm 115 have dimensions to fit a standard baby milk bottle. In this embodiment, the dimensions of the float assembly are such that the float assembly is larger than the opening of a milk bottle, requiring pushing and flexing the side arms to 110 to insert the float assembly into a milk bottle. Thus, the float assembly is entrapped in the bottle and does not accidentally exit the bottle in the absence of a deliberate action by the user. The user is subsequently informed about the milk temperature that is optimal for a baby.

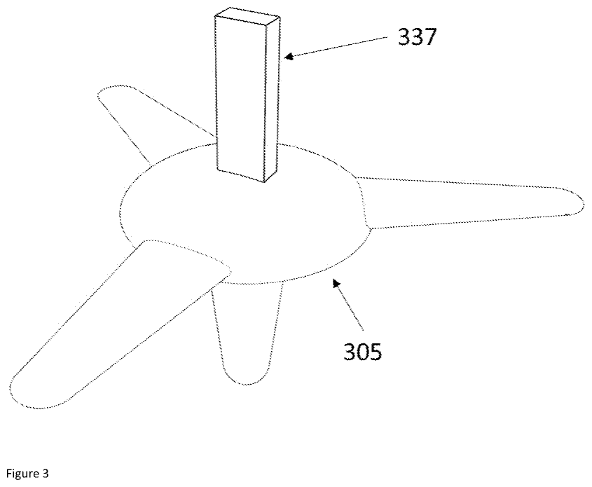

FIG. 3 shows an extraction arm 337 attached to the top of the float 305. The extraction arm 337 facilitates the removal of the float 305 from a container, such as a milk bottle. The extraction arm 337 is configured to allow the user to grab the top of the extraction arm 337 by normal means, pull it up, and remove the float assembly from the container.

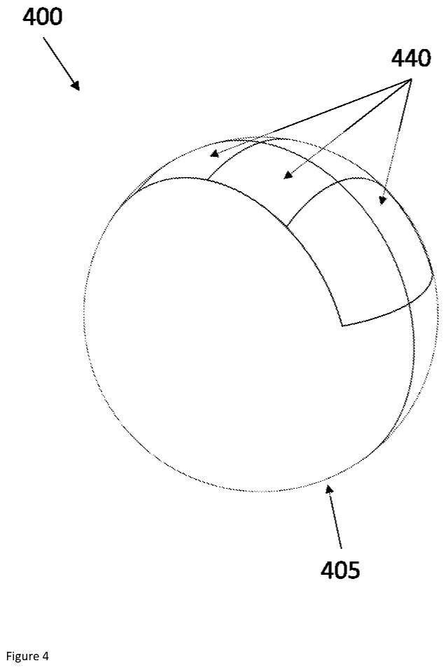

FIG. 4 shows a perspective view of an electronic device for remote fluid properties detection and reporting 400, which is a different embodiment of the present invention. As shown, the float 405 comprises an electronic sensor array 440 fabricated to detect at least one fluid property such as, but not limited to, temperature, density, impurity, colloidal particles, viscosity, color, gas content, and chemical composition.

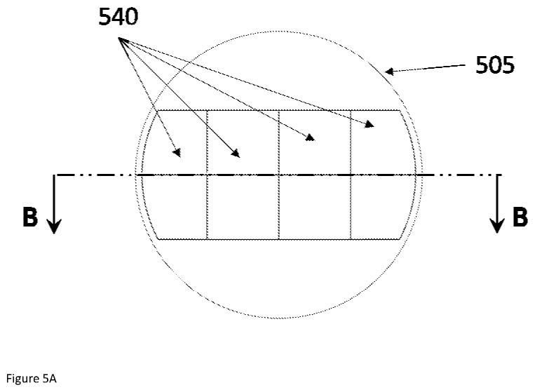

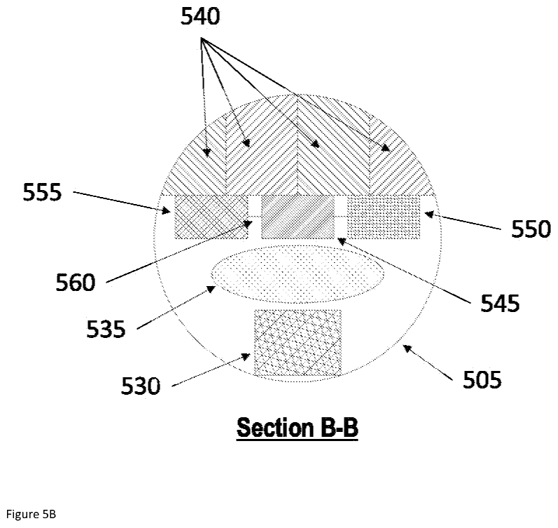

FIG. 5A shows the top view of the electronic embodiment of the present invention having the float 505 and the electronic sensor array 540. Section B-B is identified and referenced in FIG. 5B.

FIG. 5B is section B-B showing the float 505, the ballast 530, the gas bladder 535, the electronic sensor array 540, a battery 545, a microcontroller 550, an electronic transmitter 555, and a wire harness 560. The ballast 530 and the gas bladder 535 provide the aforementioned function of orienting, stabilizing, and controlling the floatation location of the float 505 in fluids. A person having ordinary skill in the art would recognize that the electronic sensor array 540, the battery 545, the microcontroller 550, and the electronic transmitter 555, are connected together via the wire harness 560. In this configuration the fluid properties of interest are detected by the electronic sensor array 540, processed by the microcontroller 550, and wirelessly transmitted to a remote receiver via the electronic transmitter 555. The battery 545 provides power to the aforementioned components. The battery is recharged via one of replacement, wired recharging, and induction.

The embodiment of the present invention shown in FIGS. 4, 5A, and 56 floats in fluids, detects the desired fluid properties via the electronic sensor array 540, and wirelessly transmits the detected properties to the user via a remote receiver.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A remote fluid properties detection comprising:
a float where in the float is located within a fluid;
a sensor array within the float, where the sensor array detects at least one fluid property;
a transmitter, where the transmitter transmits the fluid properties detected by the sensor array;
at least one of a ballast and a gas bladder within the float fashioned to orient the float within the fluid and control the float's orientation and buoyancy.

2. The remote fluid properties detection of claim 1, where in the float is composed of a thermally conductive material coated with a thermochromic compound.

3. The remote fluid properties detection of claim 2, where in the thermochromic compound is fashioned to display a specific color at a target temperature.

4. The remote fluid properties detection of claim 3, where in the thermally conductive material assumes and retains the temperature of the fluid.

5. The remote fluid properties detection of claim 4, where in the thermally conductive material transfers the fluid temperature to the thermochromic compound.

6. The remote fluid properties detection of claim 5, where in the thermochromic compound is the transmitter and provides a visual indication of the fluid temperature via the specific color.

7. The remote fluid properties detection of claim 6, where in the float has at least one side arm and at least one lower arm.

8. The remote fluid properties detection of claim 7, where in the thermally conductive material is a thermally conductive plastic.

9. The remote fluid properties detection of claim 8, where in the thermally conductive plastic is flexible.

10. The remote fluid properties detection of claim 9, where in the thermochromic compound is a thermochromic silicone.

11. The remote fluid properties detection of claim 10, where in the thermochromic compound and the thermochromic silicone are food safe.

12. The remote fluid properties detection of claim 11, where in the float is configured to fit within a baby milk bottle and transmit the target temperature of milk via the specific color.

13. The remote fluid properties detection of claim 12, where in the float has at least one extraction arm attached to the top of the float.

14. The remote fluid properties detection of claim 1, where in the sensor array senses the fluid properties.

15. The remote fluid properties detection of claim 14, where in the sensor array is an electronic sensor array.

16. The remote fluid properties detection of claim 15, where in the transmitter is an electronic transmitter.

17. The remote fluid properties detection of claim 16, where the float contains a microcontroller connected to the electronic sensor array and the electronic transmitter using a wire harness.

18. The remote fluid properties detection of claim 17, where the float contains a battery, where in the battery provides power to the microcontroller, the electronic sensor array, and the electronic transmitter via the wire harness.

19. The remote fluid properties detection of claim 18, where in the electronic sensor array detect fluid properties and conveys the fluid properties to the electronic transmitter via the microcontroller.

20. The remote fluid properties detection of claim 19, where in the electronic transmitter transmits the fluid properties to a remote receiver located away from the fluid.

21. The remote fluid properties detection of claim 20, where in the communications between the electronic transmitter and the remote receiver are wireless.
